(19) United States
(12) Patent Application Publication
(10) Pub. No.: US 2021/0219663 A1
(43) Pub. Date: Jul. 22, 2021

(54) A Shoe Upper Blank and A Method of Manufacturing Thereof

(71) Applicant: Rival Company Limited, Kowloon (HK)

(72) Inventors: Ricardo Da Costa Leite, Fanling (HK); Kuo Lang Pan, Tao Yaun City (TW)

(21) Appl. No.: 16/305,133

(22) PCT Filed: Dec. 27, 2017
(86) PCT No.: PCT/CN2017/119369

§ 371 Date: Nov. 28, 2018

(51) Int. Cl. A43B 23/04; A43B 23/02; B29D 35/12

(52) U.S. Cl. CPC A43B 23/042; B29D 35/126; A43B 23/026

(57) ABSTRACT

A method of processing a sheet material (20) for use in the manufacture of products such as, but not limited to, a shoe upper blank (10). The method comprises providing a sheet material (20); providing a two-dimensional mark (30) on a surface of the sheet material (20); imposing an indentation (40) on said surface of the sheet material (20), wherein at least part of the indentation (40) is arranged with respect to at least part of the two-dimensional mark (30) to create a three-dimensional mark (50) on said surface. A blank for such a product is also related. The blank (10) comprises a sheet material (20) shaped in accordance with the product such as a shoe upper, the sheet material (20) comprising a two-dimensional mark (30) is provided thereon and is positioned with respect to an indentation (40) formed in the sheet material (20) to thereby provide a three-dimensional mark (50) on said surface.

### FIELD OF THE INVENTION

The invention relates generally to the field of wearable product such as footwear and particularly, but not exclusively, to a shoe upper blank and a shoe upper, and a method of manufacturing thereof.

### BACKGROUND OF THE INVENTION

Various kinds of footwear such as athletic shoes in different constructions are available in the market. In general, a shoe in its typical form comprises a shoe upper which covers a foot of the wearer; and a sole or a shoe bottom which comprises the bottom portion of the shoe for supporting the foot and engaging the ground. Traditionally, blanks for shoe uppers are formed by stepwise connection of the relevant parts and components via, for example, stitching, sewing and/or binding by using adhesives and/or heat fusion techniques. In order to enhance the aesthetic appeal of the shoes as formed, decorative elements, patterns or designs are very often provided at the shoe uppers, for example, by stitching of the desired patterns and/or sewing or attaching of decorative components and/or ornaments thereon. However, all these processes are known to be time consuming as well as labor intensive, which will inevitably translate to greater costs. In addition, automation of such shoe making processes will become difficult as substantial manual operation and craftsmanship will generally still be required.

### OBJECTS OF THE INVENTION

An object of the present invention is to provide a wearable product such as a shoe and a blank for such a product, and a method of manufacturing and/or processing thereof, in which the aforesaid shortcomings are mitigated or at least to provide a useful alternative.

Another object of the invention is to mitigate or obviate to some degree one or more problems associated with known manufacturing methods of wearable products such as shoes, and/or one or more parts thereof such as shoe uppers and/or shoe upper blanks.

The above object is met by the combination of features of the main claims; the sub-claims disclose further advantageous embodiments of the invention.

One skilled in the art will derive from the following description other objects of the invention. Therefore, the foregoing statements of object are not exhaustive and serve merely to illustrate some of the many objects of the present invention.

### SUMMARY OF THE INVENTION

In a first main aspect, the invention provides a method of processing a sheet material for use in the manufacture of products. The method comprises providing a sheet material; providing a two-dimensional mark on a surface of the sheet material; imposing an indentation on said surface of the sheet material; wherein at least part of the indentation is arranged with respect to at least part of the two-dimensional mark to create a three-dimensional mark on said surface.

In a second main aspect, the invention provides a method of manufacturing a product. The method comprises forming a blank from a sheet material processed according to the method of the first main aspect to form a shoe upper.

In a third main aspect, the invention provides a blank for at least part of a manufactured product. The blank comprises a sheet material shaped in accordance with the at least part of a manufactured product, the sheet material comprising a two-dimensional mark on a surface of the sheet material; wherein at least part of the two-dimensional mark is provided thereon and is positioned with respect to an indentation formed in the sheet material to thereby provide a three-dimensional mark on said surface.

In a fourth main aspect, the invention provides a shoe upper. The shoe upper comprises the blank according to the third main aspect.

The summary of the invention does not necessarily disclose all the features essential for defining the invention; the invention may reside in a sub-combination of the disclosed features.

### BRIEF DESCRIPTION OF THE DRAWINGS

The foregoing and further features of the present invention will be apparent from the following description of preferred embodiments which are provided by way of example only in connection with the accompanying figures, of which:

FIG. 1 is a top view of the shoe upper blank in accordance with the present invention;

FIG. 2 is a top view showing an embodiment of a shoe upper blank in accordance with the present invention showing the outlines of a shoe part;

FIG. 3 shows an embodied two-dimensional mark in accordance with the present invention;

FIG. 4 shows another embodied two-dimensional mark in accordance with the present invention;

FIG. 5 is top view showing a mold applicable in preparing a blank in accordance with an embodiment of the present invention;

FIG. 6 is a bottom view of the sheet material of FIG. 3 having another layer material attached thereon;

FIG. 7 is the bottom view of the sheet material of FIG. 6 after the imposing step according to an embodiment of the present invention;

FIG. 8 is a top view of the sheet material of FIG. 7 showing the indentations at the top surface; and

FIG. 9 is a top view of the sheet material of FIG. 8 having a plurality of through holes provided at the sheet material.

### DESCRIPTION OF PREFERRED EMBODIMENTS

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

In the claims hereof, any element expressed as a means for performing a specified function is intended to encompass any way of performing that function. It is thus regarded that any means that can provide those functionalities are equivalent to those shown herein.

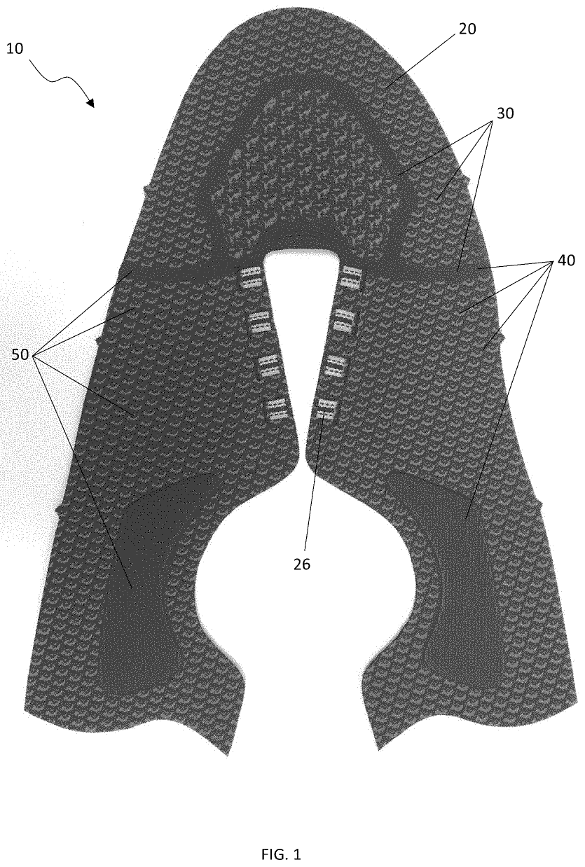

The present invention relates to a blank for a wearable product or a part of a wearable product such as a shoe upper and a method of manufacturing thereof. Referring to FIG. 1, shown is a shoe upper blank 10 according to an embodiment of the present invention. The blank 10 may comprise a sheet material 20 shaped in accordance with the shoe upper to be formed, with the sheet material 20 comprising one or more two-dimensional marks 30 on a surface of the sheet material 20. Particularly, at least part of one or more of the two-dimensional marks 30 can be provided on the surface of the sheet material 20 and positioned with respect to one or more respective indentations 40 formed in the sheet material 20 to thereby provide one or more three-dimensional marks 50 on the surface, for example the three-dimensional marks 50 as shown in the figure.

Preferably, each indentation 40 is arranged to coincide with at least part of a respective two-dimensional mark 30, and more preferably, each indentation 40 is arranged with respect to at least part of its respective two-dimensional mark 30 to thereby create a corresponding three-dimensional 50 mark to thereby mimic a textural effect in the material of the blank 10, such as but not limited to, the material of one or more of a knitted, stitched and/or sewed fabric pattern, as shown in FIG. 1.

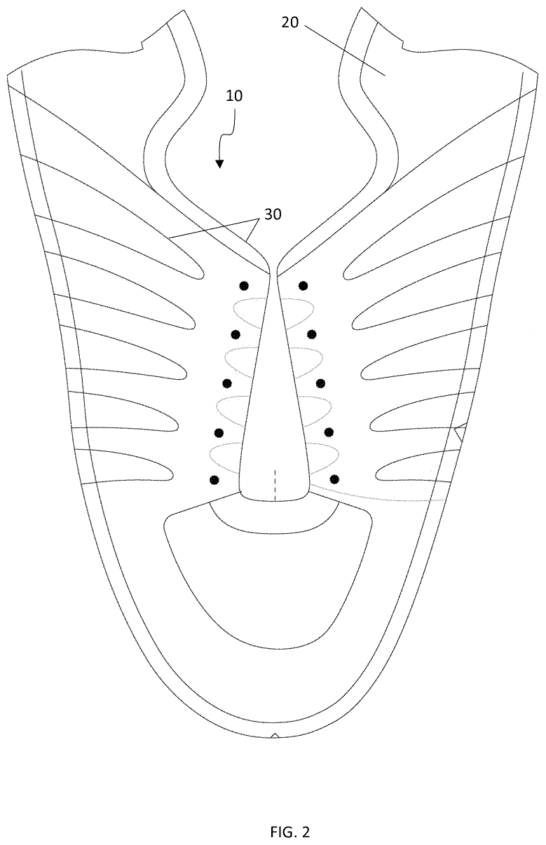

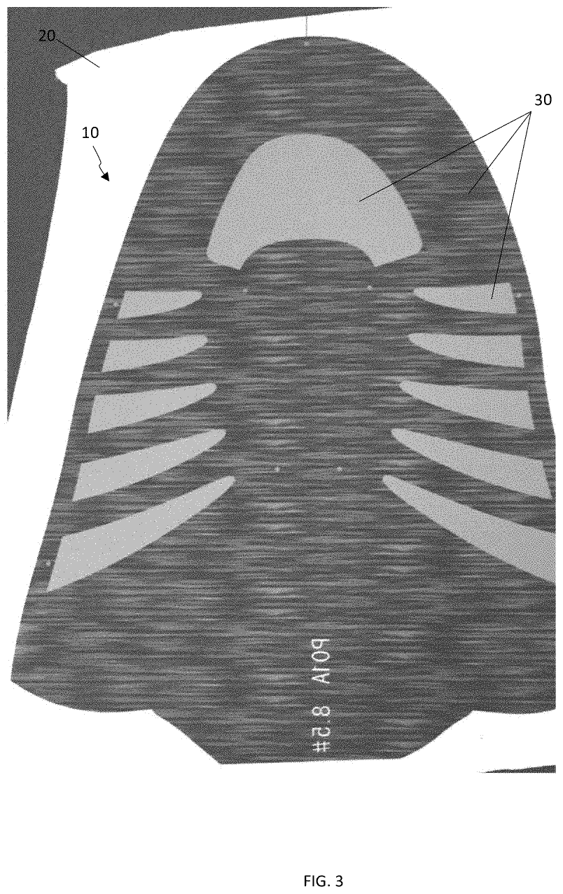

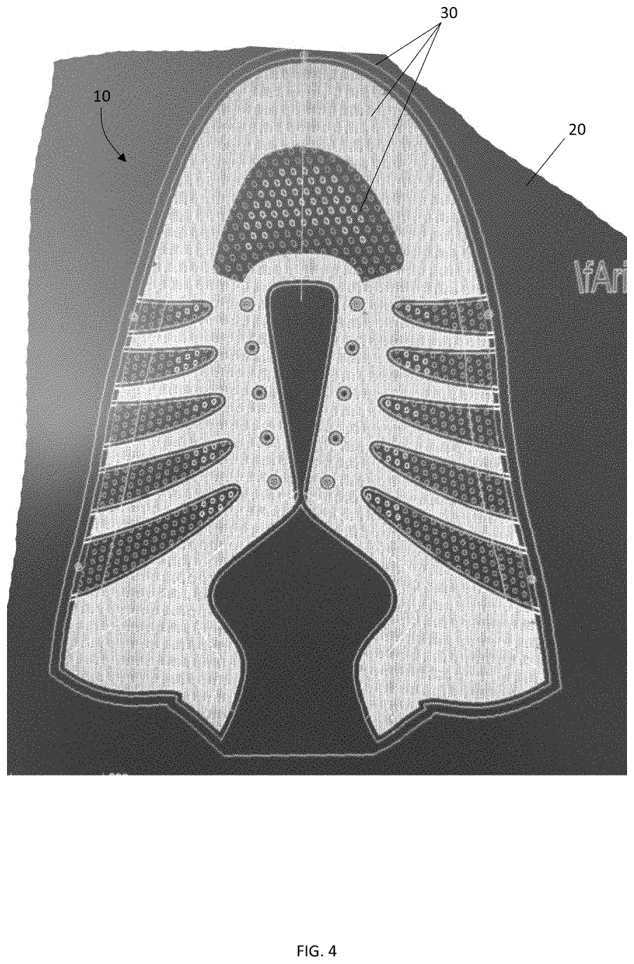

FIGS. 2-8 further illustrate the steps of manufacturing a shoe upper blank 10 in accordance with another embodiment of the present invention. First, a sheet material 20, which can be any known fabric or a composition of laminated fabric materials suitable for preparing a shoe upper blank, is provided. A two-dimensional mark 30 or a plurality of such marks 30 may then be provided on a surface, preferably the top upper surface, of the sheet material 20 by, for example, writing, drawing, painting, staining, printing and/or stamping on said surface. The two-dimensional mark 30 may comprise, for example, an outline of a part or all of the shoe upper, as shown in FIG. 2. The two-dimensional mark 30 may also comprise one or more of a line, a pattern, a color, an icon, a picture, a shape, a word and/or a symbol, such as the two-dimensional pattern as shown in FIG. 3. Preferably, the two-dimensional pattern 30 is arranged to fill at least partially the outline of the part or all of the shoe upper, as shown in FIG. 4.

In one embodiment, the two-dimensional marks or patterns 30 can be provided by any known printing techniques, such as but not limited to, sublimation printing, silk screen printing and/or digital printing. In one further embodiment, the two-dimensional patterns 30 can be formed by scanning the appearance of a fabric material having the desired texture and/or arrangement, for example, a fabric with decorative stitched patterns by a suitable scanner; optionally editing the scanned images by a computer software; and subsequently, printing of such images onto the sheet material 20 via, for example, a computer controlled printer, etc.

One or more indentations 40 will then be imposed on the printed surface of the sheet material 20, with at least part of each indentation 40 being arranged with respect to at least part of a respective two-dimensional pattern 30 to create a three-dimensional mark 50 on said surface. As described earlier, at least part of the indentation 40 is preferred to be arranged to coincide with said at least part of the two-dimensional pattern 30, and more preferably, to be arranged with respect to at least part of the two-dimensional pattern 30 to create the three-dimensional mark 50 to thereby mimic a desired textural effect such as a knitted, stitched, sewed fabric pattern and/or any design of decorative textures.

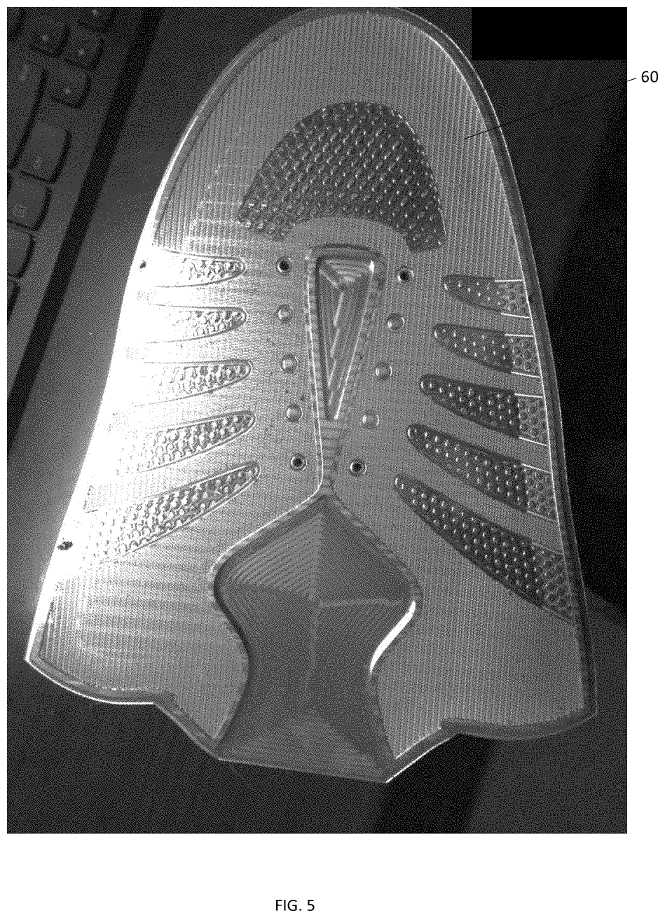

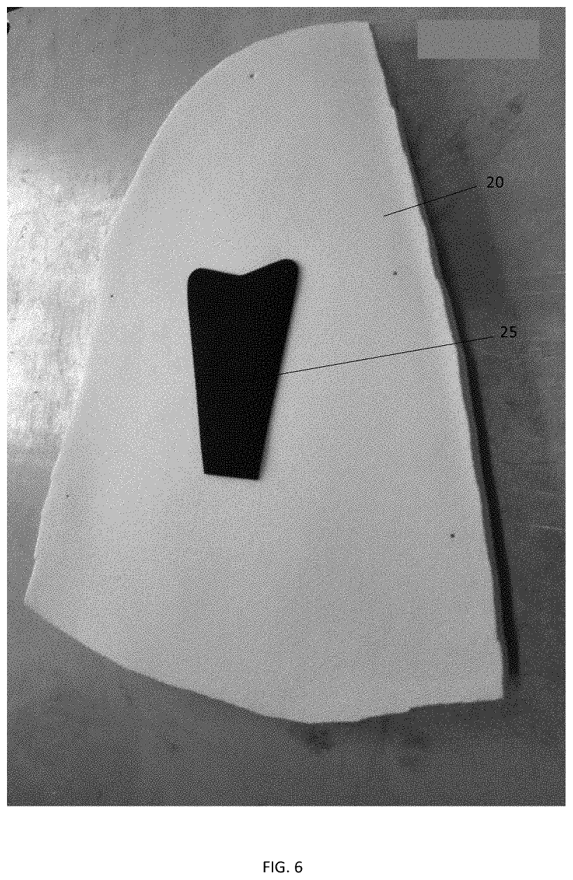

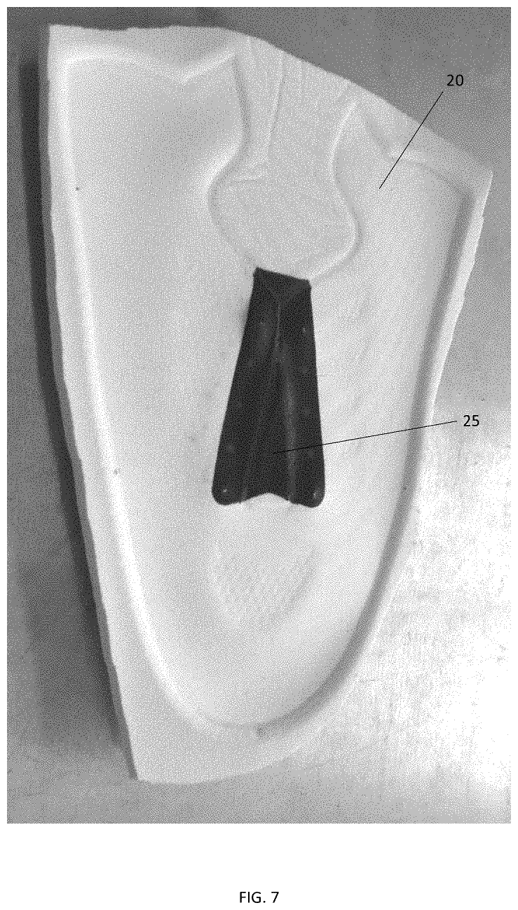

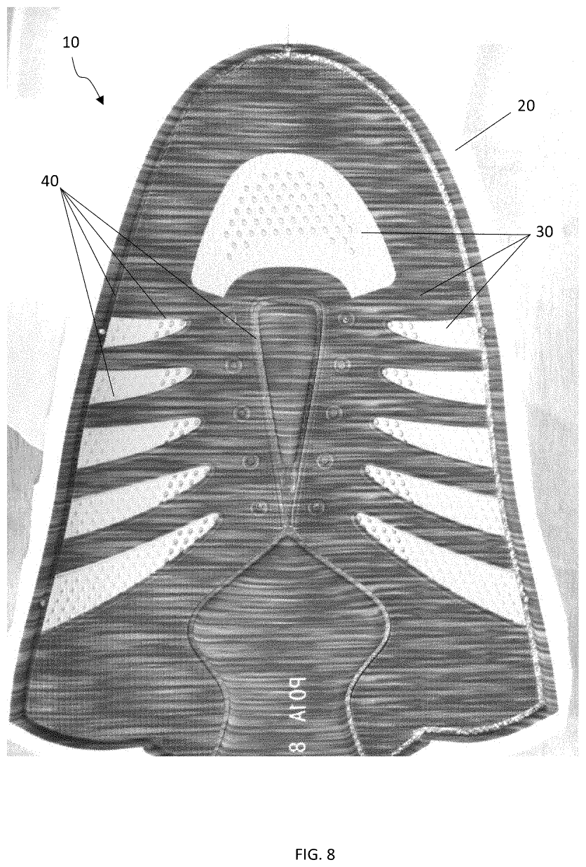

The indentation 40 can be provided by using, for example, a mold 60 such as the one as shown in FIG. 5, which is configured with respect to the positioning of the corresponding two-dimensional pattern 30 and the indentation 40 at the blank 10. Particularly, the mold 60 may comprise a molding surface carrying the mold pattern which includes, for example, a plurality of protrusions and/or recesses, with the molding surface being arranged to support, engage and/or to face the printed surface of the sheet material 20. Pressure is then applied onto the sheet material via the mold 60 to thereby impose the indentations 40 onto the printed surface. This pressing step may further be assisted by or be conducted under heat treatment, such as by heating the surface of the sheet material 20 and/or the mold 60 to enhance efficacy of the pressing step. Preferably, the sheet material 20 is to be positioned relative to the mold 60 by aligning the two-dimensional pattern 30 with the mold pattern of the mold 60 to thereby increase precision of the pressing, with the alignment being preferably assisted by using a positioning means such as one or more pins arranged at the mold 60. FIGS. 6 and 7 further illustrate the back side of the sheet material 20 before and after the pressing step, respectively; and FIG. 8 shows the front side of the sheet material 20 after the pressing step, with the imposed indentations 40 creating a three-dimensional texture 50 which mimics the effect of a stitched and/or sewed fabric pattern, for example.

In one embodiment, the 3-dimensional mark or pattern 50 can be formed by a plurality of indentations 40 on the corresponding 2-dimensional mark 30, with the indentations 40 having identical or different depths to thereby create one or more 3-D patterns. To allow formation of the indentations 40, the sheet material 20 is preferably compressible at least along a direction transverse to the printed surface. More preferably, the sheet material may be compressible by about 5% to about 30% in respect of its total thickness. In one embodiment, the sheet material 20 may be formed of one or more of materials selected from a group consisting of polyester based materials, spandex, neoprene, nylon, polyurethane based materials, synthetic leather, genuine leather, animal skins, denim, canvas, suede or suede effect materials, polyvinyl chloride, acrylic materials; and/or any fabric sheet materials which demonstrate the required compressibility such as sponge or foam sheet materials such as any one or more of ethyl vinyl acetate (EVA), polyethylene (PE), styrene butadiene rubber (SBR), polyurethane (PU), latex, or neoprene, and can be of a thickness ranged from about 0.2 mm to about 30 mm. In one further embodiment, the sheet material 20 can be a laminated sheet material having a plurality of layers of materials, with the first upper layer comprising, for example, polyester based materials, spandex, neoprene, nylon, polyurethane based materials, synthetic leather, genuine leather, animal skins, denim, canvas, suede or suede effect materials, polyvinyl chloride and/or acrylic materials. or the like, and/or preferably, with a thickness of about 0.2 mm to about 3.0 mm. The laminated sheet may further comprise a second layer of material comprising a foam material or foam-like material, with the foam material or foam-like material preferably having a thickness of about 0.2 mm to about 30 mm and/or a density of about 10 g/cm³ to about 60 g/cm³. In general, the first upper layer comprises a material which is selected to have a stiffness which retains a deformation when said material is subjected to an indentation process, while the second lower layer comprises a material with a greater degree of compressibility than the material of the first upper layer to thereby accommodate a deformation in the first upper layer. In the context of the present invention, the term “material” or “sheet material” shall not be limited to any specific material and/or fabric, or any type of materials and/or fabrics, but may comprise any suitable and/or applicable materials for wearable products and/or accessories in general.

After the provision of the 3-D marks or patterns 50 on the sheet material 20, the sheet material 20 may then be cut in accordance with the outline of the part or all of the shoe upper or the printed area of the part or all of the shoe upper to form the blank 10. In one embodiment, the blank 10 is preferred to be formed in one single piece and be configured in a substantially U or V-shape having a closed end at one longitudinal end and an open end at the opposite longitudinal end of the blank 10. The blank 10 is also preferred to be symmetric in shape along a central longitudinal axis, such that a shoe upper with symmetric left and right sides can be formed by for example, shaping and/or folding of the blank 10 about its central longitudinal axis.

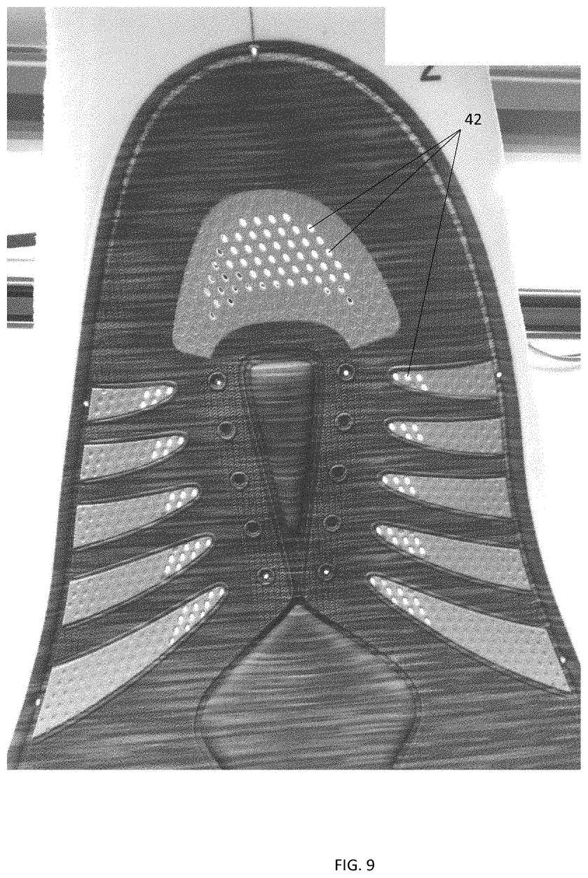

In one embodiment, the blank 10 may further comprise one or more layers of materials 25 attached to one or more surfaces and/or regions of the sheet material 20, as shown in FIGS. 6 and 7, for example. The attached layers 25 may serve to enhance or reinforce physical strength and/or to increase the thickness of the sheet material 20, such as at the regions of the eyestay, the collar lining, the vamp and/or the heel of the shoe upper, for example, at which additional strength and durability is typically required. The blank 10 may further comprise one or more shoe parts and/or accessories connected to the sheet material 20, for example, the shoelace rings 26 as shown in FIG. 1 and/or a shoe tongue (not shown). In one further embodiment, the sheet material 20 may be punched or pierced to provide one or more through holes 42, as shown in FIG. 9. The through holes 42 can be used as a passageway for a shoelace, and/or for the fitting of one or more eyelets, loops and/or hooks for tying a shoelace. Alternatively, the through holes 42 may serve a decorative purpose, for example, to allow a bottom layer material attached underneath the sheet material 20, preferably having a different color to the printed surface, to be visible via the through holes 42.

The present invention further relates to a shoe upper and a method of manufacturing thereof. Particularly, the shoe upper blank 10 as described above can be processed to form a shaped shoe upper. For example, the shoe upper can be formed by one or more of connecting, shaping, sewing, stitching, adhering and/or heat fusing steps of at least part of the blank 10. In one embodiment, the blank 10 may be connected via one or more connecting means, for example, via hot melt film pressing stitching or the like. Preferably, the shoe upper can be formed by shaping and connecting only one single blank. The present invention is therefore advantageous in providing a one-step manufacturing method, which significantly simplifies the manufacturing process for a shoe upper compared to the conventional, multi-step manufacturing process for a shoe upper. The one-step process reduces, minimises or negates the part-by-part sewing, stitching and/or in general, connecting operation in putting the various components of a conventional shoe upper blank together.

Although a footwear or a shoe in the form of a sport shoe is illustrated in the drawings, a person skilled in the relevant art would appreciate that the present invention is limited to any specific shoe types as described or illustrated. Instead, the present invention can be used to form various kinds wearable products such as, but are not limited to, footwear or shoes including boots, sandals, thongs, slippers and footwear with or without heels, and/or any wearable products or accessories of apparel such as bags, handbags, belts head or wrist bands or the like.

In general, the present invention provides a blank for a wearable product or a part of a wearable product such as a shoe upper, and a method of manufacturing thereof. The blank, preferably in a one-piece configuration, comprises a sheet material shaped in accordance with a shoe upper. The blank is printed thereon with a two-dimensional mark, with at least part of the two-dimensional mark being imposed with an indentation. The two-dimensional mark is positioned with respect to the indentation to create a three-dimensional mark or pattern for mimicking a textural effect such as, but not limited to, one or more of a knitted, stitched and/or sewed fabric pattern. The present invention is therefore advantageous in providing a simple, fast and versatile method in preparing a shoe upper blank with a texture of, for example, a knitted, stitched and/or sewed effect, without the need of an actual knitting, stitching and/or sewing step at the blank or the shoe upper. The two-dimensional mark and thus the resulting three-dimensional pattern can be any computer generated or processed graphics, photos and/or images, which can be readily produced and printable onto the sheet material by known printing methods. The imposing or impressing step is also relatively simple, fast and non-expensive, which allows the three-dimensional patterns be generated and reproduced at high efficiency and consistency. The present invention is thus beneficial in allowing a semi- or fully automated process in the making of shoe, which significantly simplifies the conventional, multi-steps manufacturing process, as well as enhances quality and reproducibility of the resulting shoes. The present invention also assists in reducing, minimising or negating some or most of the traditional manual operations generally required in a shoe making process, which are known to be cost and labour demanding.

The present description illustrates the principles of the present invention. It will thus be appreciated that those skilled in the art will be able to devise various arrangements that, although not explicitly described or shown herein, embody the principles of the invention and are included within its spirit and scope.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art.

1. A method of processing a sheet material for use in the manufacture of products, comprising:
providing a sheet material;
providing a two-dimensional mark on a surface of the sheet material;
imposing an indentation on said surface of the sheet material;
wherein at least part of the indentation is arranged with respect to at least part of the two-dimensional mark to create a three-dimensional mark on said surface.

2. The method according to claim 1, wherein said at least part of the indentation is arranged to coincide with said at least part of the two-dimensional mark.

3. The method according to claim 1, wherein said at least part of the indentation is arranged with respect to said at least part of the two-dimensional mark to create a three-dimensional mark on said surface to thereby mimic a three-dimensional textural effect of a material of a blank for at least part of a manufactured product formed from said processed sheet material.

4. The method according to claim 3, wherein the three-dimensional mark mimics a three-dimensional textural effect of the material of the blank for the at least part of the manufactured product of one or more of a knitted, stitched and/or sewed fabric pattern.

5. (canceled)

6. The method according to claim 1, wherein the step of providing the two-dimensional mark comprises providing an outline of a part or all of a blank for at least part of the manufactured product on said surface of the sheet material, and filling at least partially the outline of a part or all of the blank for the at least part of the manufactured product by a two-dimensional pattern.

7.-10. (canceled)

11. The method according to claim 1, wherein the step of imposing an indentation comprises applying pressure on said surface by using a mold to form one or more indentations.

12. (canceled)

13. The method according to claim 6, wherein the step of imposing an indentation is conducted under a pressure lower than an ambient pressure and/or comprises heat treating the surface of the sheet material.

14. (canceled)

15. The method according to claim 6, wherein the step of imposing comprises:
placing said surface of the sheet material carrying the two-dimensional mark onto and facing a molding side of the mold;
positioning the sheet material relative to the mold by aligning the two-dimensional mark with a mold pattern at the molding side of the mold; and
applying pressure to the mold carrying the sheet material.

16. (canceled)

17. The method according to claim 8, wherein the positioning step is conducted by using one or more positioning means arranged at the mold.

18. (canceled)

19. The method according to claim 1, further comprising attaching one or more layers of material to the sheet material after the imposing step.

20. The method according to claim 1, further comprising selecting a composite sheet material as the sheet material to be processed, wherein said composite sheet material comprises a first upper layer and a second lower layer, the first upper layer comprising a material which is selected to have a stiffness which retains a deformation when said material is subjected to an indentation process, and said second lower layer comprising a material with a greater degree of compressibility than the material of the first upper layer to thereby accommodate a deformation in the first upper layer.

21. The method according to claim 1, wherein the processed sheet material is processed to form a shoe upper blank and the method further comprises a step of connecting one or more shoe parts to the processed sheet material comprising the shoe upper blank after the imposing step.

22.-25. (canceled)

26. A blank for at least part of a manufactured product, comprising:
a sheet material shaped in accordance with the at least part of a manufactured product, the sheet material comprising a two-dimensional mark on a surface of the sheet material;
wherein at least part of the two-dimensional mark is provided thereon and is positioned with respect to an indentation formed in the sheet material to thereby provide a three-dimensional mark on said surface.

27.-29. (canceled)

30. The blank according to claim 13, wherein the sheet material is of a thickness ranged from about 0.2 mm to about 30 mm.

31. The blank according to claim 13, wherein the sheet material is formed of one or more of materials selected from a group consisting of polyester based materials, spandex, neoprene, nylon, polyurethane based materials, synthetic leather, genuine leather, animal skins, denim, canvas, suede or suede effect materials, polyvinyl chloride, acrylic materials, sponge materials and foam materials.

32. The blank according to claim 13, wherein the sheet material is laminated from a plurality of layers of materials; the plurality of layers of materials comprises a first upper layer of material comprising any one or more polyester based materials, spandex, neoprene, nylon, polyurethane based materials, synthetic leather, genuine leather, animal skins, denim, canvas, suede or suede effect materials, polyvinyl chloride and acrylic materials; and a second layer of material comprising a foam material.

33.-34. (canceled)

35. The blank according to claim 16, wherein the foam material comprises any one or more of ethyl vinyl acetate (EVA), polyethylene (PE), styrene butadiene rubber (SBR), polyurethane (PU), latex and neoprene.

36. The blank according to claim 16, wherein the foam material has a thickness of about 0.2 mm to about 30 mm.

37.-40. (canceled)

41. The blank according to claim 13, wherein the indentation comprises a plurality of indentations of identical depth or different depths.

42.-48. (canceled)

49. A shoe upper, comprising the blank according to claim 13.
